(19) United States
(12) Patent Application Publication
(10) Pub. No.: US 2025/0013160 A1
(43) Pub. Date: Jan. 9, 2025

(54) MANUFACTURING METHOD OF ELECTROSTATIC CHARGE IMAGE DEVELOPING TONER

(71) Applicant: FUJIFILM Business Innovation Corp., Tokyo (JP)

(72) Inventors: Takahisa TATEKAWA, Kanagawa (JP); Takahiro YAMASHITA, Kanagawa (JP); Masaru TAKAHASHI, Kanagawa (JP); Yukiaki NAKAMURA, Kanagawa (JP)

(73) Assignee: FUJIFILM Business Innovation Corp., Tokyo (JP)

(21) Appl. No.: 18/733,829

(22) Filed: Jun. 4, 2024

(30) Foreign Application Priority Data
Jul. 5, 2023 (JP) 2023-111047

(51) Int. Cl. G03G 9/08; G03G 9/087

(52) U.S. Cl. CPC G03G 9/0804; G03G 9/0819; G03G 9/08755

(57) ABSTRACT

A manufacturing method of an electrostatic charge image developing toner includes aggregating and coalescing material particles containing colorant-containing polyester resin particles in a dispersion medium to obtain toner particles, the manufacturing method including a production step of the colorant-containing polyester resin particles, in which the production step of the colorant-containing polyester resin particles includes mixing a basic colorant and a polyester resin while applying heat to obtain a mixture, and emulsifying the mixture, and in the production step of the colorant-containing polyester resin particles, a time-weighted average T° C. of a temperature of the polyester resin and a time R seconds during which the temperature of the polyester resin is in a range of 35° C. or higher and 100° C. or lower satisfy a relationship of 200≤(T×ln R)≤550.

### CROSS-REFERENCE TO RELATED APPLICATIONS

This application is based on and claims priority under 35 USC 119 from Japanese Patent Application No. 2023-111047 filed Jul. 5, 2023.

### BACKGROUND

### (i) Technical Field

The present disclosure relates to a manufacturing method of an electrostatic charge image developing toner.

### (ii) Related Art

JP2004-010846A discloses a dyed emulsion composition containing an emulsion polymer that is obtained by subjecting a monomer mixture containing a vinyl monomer (A) having a cyano group, a vinyl monomer (B) having an acidic functional group, and another vinyl monomer (C) to emulsion polymerization in the presence of an anionic surfactant (D), and a dye.

JP2010-276750A discloses a manufacturing method of a toner, including (A) a mixing step of mixing a binder resin containing a polyester having an acid group, a colorant, a basic substance, and a surfactant in an aqueous medium to obtain a mixture, (B) a molten emulsification step of heating the mixture to a temperature higher than a softening temperature Tm of the binder resin by 10° C. or higher while applying a shear force to obtain a molten emulsion, (C) a cooling step of cooling the molten emulsion at a cooling rate of 0.5° C./min or more and 10° C./min or less to a temperature equal to or lower than a glass transition temperature Tg of the binder resin while applying a shear force to produce a fine particle dispersion in which a median diameter is 1.0 μm or less, and (D) a step of aggregating the fine particle dispersion in the aqueous medium.

JP2021-127428A discloses resin fine particles containing a polyester resin and a basic dye, in which a volume-average particle size of the resin fine particles is 0.05 μm or more and 1 μm or less, and a concentration ratio of the basic dye at a center-of-gravity portion of the resin fine particles with respect to a surface layer portion of the resin fine particles at a depth of 10 nm or less from a surface of the resin fine particles is 0.8 or more.

### SUMMARY

Aspects of non-limiting embodiments of the present disclosure relate to a manufacturing method of manufacturing an electrostatic charge image developing toner that suppresses occurrence of image density unevenness and has excellent heat storage properties.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific methods for achieving the above-described object include the following aspects.

According to an aspect of the present disclosure, there is provided a manufacturing method of an electrostatic charge image developing toner, that includes aggregating and coalescing material particles containing colorant-containing polyester resin particles in a dispersion medium to obtain toner particles, the manufacturing method including: a production step of the colorant-containing polyester resin particles, in which the production step of the colorant-containing polyester resin particles includes mixing a basic colorant and a polyester resin while applying heat to obtain a mixture, and emulsifying the mixture, and in the production step of the colorant-containing polyester resin particles, a time-weighted average T° C. of a temperature of the polyester resin and a time R seconds during which the temperature of the polyester resin is in a range of 35° C. or higher and 100° C. or lower satisfy a relationship of 200≤(T×ln R)≤550.

### DETAILED DESCRIPTION

The exemplary embodiments of the present disclosure will be described below. The following descriptions and examples merely illustrate the exemplary embodiments, and do not limit the scope of the exemplary embodiments.

In the present disclosure, a numerical range described using “to” represents a range including numerical values listed before and after “to” as the minimum value and the maximum value respectively.

Regarding the numerical ranges described in stages in the present disclosure, the upper limit value or lower limit value of a numerical range may be replaced with the upper limit value or lower limit value of another numerical range described in stages. Furthermore, in the present disclosure, the upper limit or lower limit of a numerical range may be replaced with values described in examples.

In the present disclosure, the term “step” includes not only an independent step but a step that is not clearly distinguished from other steps as long as the purpose of the step is achieved.

In the present disclosure, each component may include a plurality of corresponding substances. In a case where the amount of each component in a composition is mentioned in the present disclosure, and there are two or more kinds of substances corresponding to each component in the composition, unless otherwise specified, the amount of each component means the total amount of two or more kinds of the substances present in the composition.

In the present disclosure, each component may include two or more kinds of corresponding particles. In a case where there are two or more kinds of particles corresponding to each component in a composition, unless otherwise specified, the particle size of each component means a value for a mixture of two or more kinds of the particles present in the composition.

In the present disclosure, “(meth)acrylic” is an expression including both acrylic and methacrylic, and “(meth)acrylate” is an expression including both acrylate and methacrylate.

In the present disclosure, a “toner” refers to an “electrostatic charge image developing toner”, a “developer” refers to an “electrostatic charge image developer”, and a “carrier” refers to an “electrostatic charge image developing carrier”.

In the present disclosure, a method of manufacturing toner particles by aggregating and coalescing material particles in a dispersion medium is referred to as an emulsion aggregation (EA) method.

### Manufacturing Method of Electrostatic Charge Image Developing Toner

The manufacturing method of the toner according to the present exemplary embodiment is a manufacturing method of a toner including manufacturing toner particles by the EA method.

In the manufacturing method of the toner according to the present exemplary embodiment, at least colorant-containing polyester resin particles are used as material particles.

Therefore, the manufacturing method of the toner according to the present exemplary embodiment includes obtaining toner particles by aggregating and coalescing material particles containing the colorant-containing polyester resin particles in a dispersion medium.

Specifically, the manufacturing method of the toner according to the present exemplary embodiment includes a production step of the colorant-containing polyester resin particles, in which the production step of the colorant-containing polyester resin particles includes mixing a basic colorant and a polyester resin while applying heat to obtain a mixture, and emulsifying the mixture, and in the production step of the colorant-containing polyester resin particles, a time-weighted average T° C. of a temperature of the polyester resin and a time R seconds during which the temperature of the polyester resin is in a range of 35° C. or higher and 100° C. or lower satisfy a relationship of 200≤(T×ln R)≤550.

In the production step of the colorant-containing polyester resin particles, the temperature of the polyester resin may be kept constant or may fluctuate. In a case where the temperature of the polyester resin fluctuates, a time when the temperature is lower than 35° C. or a time when the temperature is higher than 100° C. may be allowed, but in the entire production step of the colorant-containing polyester resin particles, for example, it is preferable that the temperature of the polyester resin is in the range of 35° C. or higher and 100° C. or lower.

The time-weighted average T° C. of the temperature of the polyester resin is a value obtained by averaging the temperature of the polyester resin during the production step of the colorant-containing polyester resin particles with weighting for the time during which the temperature is maintained.

ln R represents a natural logarithm of R.

According to the manufacturing method of the toner according to the present exemplary embodiment, a toner that suppresses occurrence of image density unevenness and has excellent heat storage properties is manufactured. The mechanism is assumed as follows.

As a method for stably manufacturing toner particles having a particle size of several μm, the EA method has been known. However, depending on the type of a material used in the EA method, material particles may not be uniformly dispersed from each other, and a specific material may be unevenly distributed in the toner particles in a lump. In such a toner and a developer containing such toner particles, charge leakage is likely to occur, and image density unevenness may occur. For example, in a case where polyester resin particles and basic colorant particles are used as the material particles in the EA method, the basic colorant may be unevenly distributed in the toner particles in a lump, and the image density unevenness may occur.

In the present exemplary embodiment, first, as a measure for suppressing the above-described phenomenon, the basic colorant particles that are the material particles of the EA method are particles containing not only the basic colorant but also a polyester resin. As a result, it is possible to suppress the uneven distribution of the basic colorant in the form of a lump inside the toner particles.

In the production step of the colorant-containing polyester resin particles in the present exemplary embodiment, a temperature and a heating time, at which the polyester resin is exposed, are controlled. Since the polyester resin is easily hydrolyzed by an action of the basic colorant, the hydrolysis of the polyester resin is suppressed by controlling the temperature and the time of the production step of the colorant-containing polyester resin particles. As a result, a molecular weight of the polyester resin is maintained, and the toner is less likely to aggregate even in a case in which the toner after the production is left at a high temperature for a long time.

In the production step of the colorant-containing polyester resin particles, from the viewpoint of improving dispersibility of the basic colorant, for example, it is preferable that a temperature of the dispersion during granulation is high. On the other hand, as the temperature of the dispersion during granulation is higher, the hydrolysis of the polyester resin is likely to proceed. In the production step of the colorant-containing polyester resin particles in the present exemplary embodiment, the time-weighted average T° C. of the temperature of the polyester resin and the time R seconds during which the temperature of the polyester resin is in a range of 35° C. or higher and 100° C. or lower are controlled to satisfy the relationship of 200≤(T×ln R)≤550.

In a case where (T×ln R) is less than 200, the dispersion of the basic colorant in the polyester resin is insufficient, and the image density unevenness may occur. From the viewpoint of suppressing the event, (T×ln R) is 200 or more, and for example, preferably 250 or more and more preferably 300 or more.

In a case where (T×ln R) is more than 550, the hydrolysis of the polyester resin proceeds, and heat-resistant storage stability of the toner after the production may be deteriorated. From the viewpoint of suppressing the event, (T×ln R) is 550 or less, and for example, preferably 500 or less and more preferably 450 or less.

From the viewpoint of controlling the (T×ln R) in the above-described range, in the entire production step of the colorant-containing polyester resin particles, the temperature of the polyester resin is, for example, preferably in a range of 35° C. or higher and 100° C. or lower, more preferably in a range of 38° C. or higher and 98° C. or lower, and still more preferably in a range of 40° C. or higher and 95° C. or lower.

Specifically, in the present exemplary embodiment, for example, it is preferable that the manufacturing of the toner particles by the EA method includes an aggregation step of aggregating material particles in a dispersion containing the material particles to form aggregated particles; and a coalescence step of heating the dispersion containing the aggregated particles for coalescing the aggregated particles together to form toner particles.

The material particles include colorant-containing polyester resin particles containing a basic colorant and a polyester resin.

Hereinafter, the production step of the colorant-containing polyester resin particles each step of the EA method, and materials in the present exemplary embodiment will be described in detail.

### Production Step of Colorant-Containing Polyester Resin Particles

The production step of the colorant-containing polyester resin particles includes mixing a basic colorant and a polyester resin while applying heat to obtain a mixture, and emulsifying the mixture.

From the viewpoint that the basic colorant is likely to be uniformly present inside the colorant-containing polyester resin particles and inside the toner particles, a mass ratio of the basic colorant and the polyester resin contained in the colorant-containing polyester resin particles, as basic colorant:polyester resin, is, for example, preferably 0.1:99.9 to 20:80, more preferably 0.5:99.5 to 15:85, and still more preferably 1:99 to 10:90.

From the viewpoint of uniform dispersion and easy aggregation in the aggregation step of the EA method, a volume-average particle size of the colorant-containing polyester resin particles is, for example, preferably 50 nm or more and 500 nm or less, more preferably 65 nm or more and 400 nm or less, and still more preferably 80 nm or more and 300 nm or less.

The volume-average particle size of the colorant-containing polyester resin particles refers to a particle size at which 50% of the particles are accumulated from a small size side in a particle size distribution measured with a laser diffraction-type particle size distribution analyzer (for example, model number: LS13-320, Beckman Coulter, Inc.). The number of particles to be measured is 10,000.

### Basic Colorant

One kind of basic colorant may be used alone, or two or more kinds of basic colorants may be used in combination.

Examples of the basic colorant include a basic dye and a basic pigment. As the basic colorant, only a basic dye may be used, only a basic pigment may be used, or a basic dye and a basic pigment may be used in combination.

Examples of the basic colorant include a fluorescent colorant. As the basic colorant, only a non-fluorescent colorant may be used, only a fluorescent colorant may be used, or a non-fluorescent colorant and a fluorescent colorant may be used in combination.

Examples of the basic dye include a diazine-based dye, an oxazine-based dye, a thiazine-based dye, an azo-based dye, an anthraquinone-based dye, a xanthene-based dye, a triarylmethane-based dye, a phthalocyanine-based dye, an auramine-based dye, an acridine-based dye, and a methine-based dye. Specific examples thereof include the following dyes:

diazine-based dyes such as Basic Red 2, 5, 6, and 10, Basic Blue 13, 14, and 16, Basic Violet 5, 6, 8, and 12, and Basic Yellow 14; oxazine-based dyes such as Basic Blue 3, 6, 10, 12, and 74; thiazine-based dyes such as Basic Blue 9, 17, 24, and 25, and Basic Green 5; azo-based dyes such as Basic Red 18, 22, 23, 24, 29, 30, 31, 32, 34, 38, 39, 46, 51, 53, 54, 55, 62, 64, 76, 94, 111, and 118, Basic Blue 41, 53, 54, 55, 64, 65, 66, 67, and 162, Basic Violet 18 and 36, Basic Yellow 15, 19, 24, 25, 28, 29, 38, 39, 49, 51, 57, 62, and 73, and Basic Orange 1, 2, 24, 25, 29, 30, 33, 54, and 69; anthraquinone-based dyes such as Basic Blue 22, 44, 47, and 72; xanthene-based dyes such as Basic Red 1, 1:1, 3, 4, 8, and 11, Basic Violet 10, 11, and 11:1; triarylmethane-based dyes such as Basic Red 9, Basic Blue 1, 2, 5, 7, 8, 11, 15, 18, 20, 23, 26, 35, and 81, Basic Violet 1, 2, 3, 4, 14, and 23, and Basic Green 1 and 4; phthalocyanine-based dyes such as Basic Blue 140; auramine-based dyes such as Basic Yellow 2, 3, and 37; acridine-based dyes such as Basic Yellow 5, 6, 7, and 9, Basic Orange 4, 5, 14, 15, 16, 17, 18, 19, and 23; and methine-based dyes such as Basic Red 12, 13, 14, 15, 27, 28, 37, 52, and 90, Basic Yellow 11, 13, 20, 21, 52, and 53, Basic Orange 21 and 22, and Basic Violet 7, 15, 16, 20, 21, and 22.

Examples of the basic pigment include an azo-based pigment and a quinacridone-based pigment. Specific examples thereof include the following pigments:

azo-based pigments such as Pigment Red 146 and 166, Pigment Yellow 1, 13, 74, 83, and 180; and quinacridone-based pigments such as Pigment Orange 48 and 49, Pigment Red 122, 202, 206, 207, and 209, and Pigment Violet 19.

As the fluorescent basic colorant, from the viewpoint of fluorescence intensity, for example, Basic Red 1 (Rhodamine 6G), Basic Red 1:1, Basic Red 2, Basic Red 12, Basic Red 13, Basic Red 14, Basic Red 15, Basic Red 36, Basic Violet 7, Basic Violet 10 (Rhodamine B), Basic Violet 11 (Rhodamine 3B), Basic Violet 11:1 (Rhodamine A), Basic Violet 15, Basic Violet 16, Basic Violet 27, Basic Yellow 1, Basic Yellow 2, Basic Yellow 9, Basic Yellow 24, Basic Yellow 40, Basic Orange 15, Basic Orange 22, Basic Blue 1, Basic Blue 3, Basic Blue 7, Basic Blue 9, Basic Blue 45, or Basic Green 1 is preferable; and Basic Red 1 (Rhodamine 6G), Basic Red 1:1, Basic Red 2, Basic Red 12, Basic Red 13, Basic Red 14, Basic Red 15, Basic Red 36, Basic Violet 7, Basic Violet 10 (Rhodamine B), Basic Violet 11 (Rhodamine 3B), Basic Violet 11:1 (Rhodamine A), Basic Violet 15, Basic Violet 16, or Basic Violet 27 is more preferable.

### Polyester Resin

Examples of the polyester resin include an amorphous polyester resin and a crystalline polyester resin. As the polyester resin, only an amorphous polyester resin may be used, only a crystalline polyester resin may be used, or an amorphous polyester resin and a crystalline polyester resin may be used in combination. As the polyester resin, for example, an amorphous polyester resin is suitable.

### Amorphous Polyester Resin

As the amorphous polyester resin, a commercially available product may be used, or a synthetic resin may be used.

Examples of the amorphous polyester resin include a polycondensate of a polyvalent carboxylic acid and a polyhydric alcohol.

Examples of the polyvalent carboxylic acid that is a polymerization component of the amorphous polyester resin include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, phthalic acid, naphthalenedicarboxylic acid, and the like), anhydrides of these, and lower alkyl esters (for example, having 1 or more and 5 or less carbon atoms). Among the above, for example, aromatic dicarboxylic acids are preferable as the polyvalent carboxylic acid.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

One kind of polyvalent carboxylic acid may be used alone, or two or more kinds of polyvalent carboxylic acids may be used in combination.

Examples of the polyhydric alcohol that is a polymerization component of the amorphous polyester resin include aliphatic diols (for example, ethylene glycol, diethylene glycol, triethylene glycol, propylene glycol, neopentyl glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among the above, for example, aliphatic diols are preferable as the polyhydric alcohol.

As the polyhydric alcohol that is a polymerization component of the amorphous polyester resin, a polyhydric alcohol having a valency of 3 or more and a crosslinked structure or a branched structure may be used in combination with a diol. Examples of the polyhydric alcohol having a valency of 3 or more include glycerin, trimethylolpropane, and pentaerythritol.

One kind of polyhydric alcohol may be used alone, or two or more kinds of polyhydric alcohols may be used in combination.

A glass transition temperature (Tg) of the amorphous polyester resin is, for example, preferably 50° C. or higher and 75° C. or lower, more preferably 50° C. or higher and 70° C. or lower, and still more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

A weight-average molecular weight (Mw) of the amorphous polyester resin is, for example, preferably 5,000 or more and 1,000,000 or less, and more preferably 7,000 or more and 500,000 or less.

A number-average molecular weight (Mn) of the amorphous polyester resin is, for example, preferably 2,000 or more and 100,000 or less.

A molecular weight distribution Mw/Mn of the amorphous polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC·HLC-8120GPC manufactured by Tosoh Corporation as a measurement device, TSKgel Super HM-M (15 cm) manufactured by Tosoh Corporation as a column, and THF as a solvent. The weight-average molecular weight and the number-average molecular weight are calculated using a molecular weight calibration curve plotted using a monodisperse polystyrene standard sample from the measurement results.

An acid value of the amorphous polyester resin is, for example, preferably 1 mgKOH/g or more and 50 mgKOH/g or less, more preferably 3 mgKOH/g or more and 30 mgKOH/g or less, and still more preferably 5 mgKOH/g or more and 18 mgKOH/g or less.

The acid value of the amorphous polyester resin is determined by a neutralization titration method specified in JIS K 0070-1992 using an appropriate amount of the amorphous polyester resin as a sample.

The amorphous polyester resin is obtained by a known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation.

In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is distilled off. In a case where a monomer with poor compatibility takes part in the copolymerization reaction, for example, the monomer with poor compatibility may be condensed in advance with an acid or an alcohol that is to be polycondensed with the monomer, and then polycondensed with the major component.

### Crystalline Polyester Resin

As the crystalline polyester resin, a commercially available product may be used, or a synthetic resin may be used.

Examples of the crystalline polyester resin include a polycondensate of polyvalent carboxylic acid and polyhydric alcohol. Since the crystalline polyester resin easily forms a crystal structure, the crystalline polyester resin is, for example, preferably a polycondensate formed of a linear aliphatic polymerizable monomer than a polycondensate formed of a polymerizable monomer having an aromatic ring.

Examples of the polyvalent carboxylic acid that is a polymerization component of the crystalline polyester resin include aliphatic dicarboxylic acids (for example, oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (for example, dibasic acids such as phthalic acid, isophthalic acid, terephthalic acid, and naphthalene-2,6-dicarboxylic acid), anhydrides of these dicarboxylic acids, and lower alkyl esters (for example, having 1 or more and 5 or less carbon atoms) of these dicarboxylic acids.

As the polyvalent carboxylic acid, a carboxylic acid having a valency of 3 or more that has a crosslinked structure or a branched structure may be used in combination with a dicarboxylic acid. Examples of the trivalent carboxylic acids include aromatic carboxylic acid (for example, 1,2,3-benzenetricarboxylic acid, 1,2,4-benzenetricarboxylic acid, 1,2,4-naphthalenetricarboxylic acid, and the like), anhydrides of these aromatic carboxylic acids, and lower alkyl esters (for example, having 1 or more and 5 or less carbon atoms) of these aromatic carboxylic acids.

As the polyvalent carboxylic acid, a dicarboxylic acid having a sulfonic acid group or a dicarboxylic acid having an ethylenically double bond may be used together with these dicarboxylic acids.

One kind of polyvalent carboxylic acid may be used alone, or two or more kinds of polyvalent carboxylic acids may be used in combination.

Examples of the polyhydric alcohol that is a polymerization component of the crystalline polyester resin include an aliphatic diol (for example, a linear aliphatic diol having 7 or more and 20 or less carbon atoms in a main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol.

As the polyhydric alcohol that is a polymerization component of the crystalline polyester resin, an alcohol having a valency of 3 or more and having a crosslinked structure or a branched structure may be used in combination with a diol. Examples of the alcohol having a valency of 3 or more include glycerin, trimethylolethane, and trimethylolpropane, pentaerythritol.

One kind of polyhydric alcohol may be used alone, or two or more kinds of polyhydric alcohols may be used in combination.

A melting temperature of the crystalline polyester resin is, for example, preferably 50° C. or higher and 100° C. or lower, more preferably 55° C. or higher and 90° C. or lower, and still more preferably 60° C. or higher and 85° C. or lower.

The melting temperature is determined from a DSC curve obtained by differential scanning calorimetry (DSC) by “peak melting temperature” described in the method for determining the melting temperature in JIS K7121-1987, “Testing methods for transition temperatures of plastics”.

A weight-average molecular weight (Mw) of the crystalline polyester resin is, for example, preferably 6,000 or more and 35,000 or less.

The crystalline polyester resin can be obtained by a known manufacturing method, for example, same as the amorphous polyester resin.

For example, the colorant-containing polyester resin particles are preferably produced in a form of a dispersion containing the particles. That is, the production step of the colorant-containing polyester resin particles is, for example, preferably a step of producing a dispersion of the colorant-containing polyester resin particles.

From the viewpoint of containing a sufficient amount of the colorant in the toner particles, a concentration of solid contents of the dispersion of the colorant-containing polyester resin particles is, for example, preferably 10% by mass or more, more preferably 15% by mass or more, and still more preferably 20% by mass or more.

From the viewpoint of dispersibility of the particles, the concentration of solid contents of the dispersion of the colorant-containing polyester resin particles is, for example, preferably 50% by mass or less, more preferably 45% by mass or less, and still more preferably 40% by mass or less.

Hereinafter, the “solventless emulsification” and the “solvent emulsification” that are examples of exemplary embodiments of the production step of the colorant-containing polyester resin particles will be described. The solventless emulsification and the solvent emulsification are carried out to produce the dispersion of the colorant-containing polyester resin particles.

### Solventless Emulsification

The solventless emulsification is a method in which an organic solvent is not used in the production step of the colorant-containing polyester resin particles.

Specifically, the solventless emulsification includes a melting step of mixing a basic colorant, a polyester resin, a basic compound (excluding the basic colorant), and a surfactant by applying heat and a shear force to obtain a mixture in which the basic colorant is dispersed in a melted polyester resin; and an emulsification step of adding an aqueous medium to the mixture while applying a shear force to the mixture to perform emulsification.

The time-weighted average T° C. of the temperature and the time R seconds in the solventless emulsification refer to a temperature T° C. and a time R seconds from the start of the melting step to the end of the emulsification step.

In the solventless emulsification, for example, it is preferable that the melting step and the emulsification step are carried out using a kneading extruder. The kneading extruder is a device that applies heat and a shear force to materials to be treated while continuously transporting the materials to be treated. In general, a structure of the kneading extruder is substantially divided into a material inlet, a barrel, and a die in this order from the upstream to the downstream. A screw is provided inside the barrel. A heater for heating the inside of the barrel is provided around the barrel. The screw may be uniaxial or biaxial, and for example, a biaxial screw is preferable.

As the basic compound, for example, sodium hydroxide or potassium hydroxide is suitable. From the viewpoint of kneading uniformity, for example, it is preferable that sodium hydroxide or potassium hydroxide is used in a form of an aqueous solution (that is, sodium hydroxide aqueous solution or potassium hydroxide aqueous solution).

An amount of the basic compound used is an amount capable of achieving emulsification and dispersion of the mixture. Specifically, the amount of the basic compound used is, for example, preferably an amount at which a neutralization rate according to the following expression (1) is 30% or more and 80% or less.

Neutralization rate (%)=mb×n×56.1→Mwb→AV×1000 Expression (1):
mb is the amount (g) of the basic compound used per 1 g of the polyester resin,
n is a valence of the basic compound,
Mwb is a molecular weight of the basic compound, and
AV is an acid value (mgKOH/g) of the polyester resin.

The surfactant may be any of an anionic surfactant, a cationic surfactant, or a nonionic surfactant. Examples thereof include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. One kind of surfactant may be used alone, or two or more kinds of surfactants may be used in combination. The nonionic surfactant may be used in combination with the anionic surfactant or the cationic surfactant.

An amount of the surfactant used is an amount at which the emulsified particles can maintain the dispersion.

As the aqueous medium, for example, water having a reduced ion content, such as distilled water and deionized water, is preferable. The aqueous medium is used, for example, preferably in a state of being adjusted to a temperature in a range of 35° C. or higher and 100° C. or lower, and more preferably in a state of being adjusted to a temperature in a range of +5° C. of the inside of the barrel of the kneading extruder.

In the melting step, the temperature inside the barrel of the kneading extruder is, for example, preferably 80° C. or higher and 110° C. or lower, more preferably 85° C. or higher and 105° C. or lower, and still more preferably 90° C. or higher and 100° C. or lower.

In the emulsification step, the temperature inside the barrel of the kneading extruder is, for example, preferably 80° C. or higher and 110° C. or lower, more preferably 85° C. or higher and 105° C. or lower, and still more preferably 90° C. or higher and 100° C. or lower.

In a case of using a biaxial kneading extruder, an average supply amount of the mixture supplied from the melting step to the emulsification step, as a value obtained by dividing the supply amount (kg/h) by the cube of a shaft diameter (cm), is, for example, preferably 0.15 kg/(h·cm³) or more and 3.0 kg/(h cm³) or less, more preferably 0.5 kg/(h cm³) or more and 2.5 kg/(h·cm³) or less, and still more preferably 0.8 kg/(h cm³) or more and 2.0 kg/(h cm³) or less.

In the entire melting step and emulsification step, L/D (a ratio of a screw length L to a screw diameter D) of the kneading extruder is, for example, preferably 30 or more and 90 or less, more preferably 40 or more and 80 or less, and still more preferably 50 or more and 70 or less.

### Solvent Emulsification

Specifically, the solvent emulsification includes a dissolving step of mixing a basic colorant, a polyester resin, and an organic solvent in which the polyester resin is soluble by applying heat to obtain a mixture in which the polyester resin is dissolved in the organic solvent and the basic colorant is dissolved or dispersed in the organic solvent; and an emulsification step of adding a basic compound to the mixture, and adding an aqueous medium to the mixture to disperse the mixture in the aqueous medium in a particulate form.

The time-weighted average T° C. of the temperature and the time R seconds in the solvent emulsification refer to a temperature T° C. and a time R seconds from the start of the dissolving step to the end of the emulsification step.

In the solvent emulsification, for example, it is preferable that the dissolving step and the emulsification step are carried out in an agitated vessel provided with an agitation unit and a heating and cooling unit. The agitation unit is, for example, preferably an agitation unit including a rotation shift and an agitation blade. The heating and cooling unit is, for example, a unit that applies and/or absorbs heat from a wall surface of the agitated vessel.

Examples of the organic solvent in which the polyester resin is soluble include ethyl acetate, isopropanol, 2-butanol, methyl ethyl ketone, and a mixed solvent thereof. Among the above, for example, an organic solvent or a mixed solvent having a boiling point of 60° C. or higher and lower than 100° C. is preferable.

As the basic compound, for example, aqueous ammonia is suitable.

An amount of the basic compound used is an amount capable of achieving emulsification and dispersion of the mixture. Specifically, the amount of the basic compound used is, for example, preferably an amount at which a neutralization rate according to the following expression (1) is 50% or more and 100% or less.

Neutralization rate (%)=mb×n×56.1→Mwb→AV×1000 Expression (1):
mb is the amount (g) of the basic compound used per 1 g of the polyester resin,
n is a valence of the basic compound,
Mwb is a molecular weight of the basic compound, and
AV is an acid value (mgKOH/g) of the polyester resin.

As the aqueous medium, for example, water having a reduced ion content, such as distilled water and deionized water, is preferable. For example, it is preferable that the aqueous medium is used by adjusting a temperature to a range of 35° C. or higher and 100° C. or lower (for example, preferably 35° C. or higher and 55° C. or lower).

In the dissolving step, a temperature of the materials to be treated, contained in the agitated vessel, is, for example, preferably 25° C. or higher and 60° C. or lower, more preferably 30° C. or higher and 55° C. or lower, and still more preferably 35° C. or higher and 50° C. or lower.

In the emulsification step, a temperature of the materials to be treated, contained in the agitated vessel, is, for example, preferably 25° C. or higher and 60° C. or lower, more preferably 30° C. or higher and 55° C. or lower, and still more preferably 35° C. or higher and 50° C. or lower.

The method of adding the aqueous medium in the emulsification step is, for example, preferably dropwise addition.

A dropping time of a specified amount (twice the amount of the resin) of the aqueous medium in the emulsification step is, for example, preferably 10 minutes or more and 150 minutes or less, more preferably 20 minutes or more and 140 minutes or less, and still more preferably 30 minutes or more and 130 minutes or less.

After the addition of the aqueous medium is completed, for example, it is preferable to reduce a pressure inside the agitated vessel and/or to bubble the emulsion to remove the organic solvent. Thereafter, in order to improve dispersion stability of the particles, a surfactant may be added. Examples of the surfactant include the anionic surfactant, the cationic surfactant, and the nonionic surfactant described above.

### Production Step of Other Material Particles

Examples of other material particles include binder resin particles and release agent particles. For example, it is preferable that the binder resin particles are produced in a form of a dispersion containing the binder resin particles. For example, it is preferable that the release agent particles are produced in a form of a dispersion containing the release agent particles.

Hereinafter, common features of the dispersion of the binder resin particles and the dispersion of the release agent particles will be collectively referred to as “particle dispersion”.

An example of an exemplary embodiment of the particle dispersion is a dispersion obtained by dispersing a material in a dispersion medium in a particulate form, using a surfactant.

As the dispersion medium of the particle dispersion, for example, an aqueous medium is preferable. Examples of the aqueous medium include water and alcohol. As the water, for example, water having a reduced ion content, such as distilled water and deionized water, is preferable. One kind of aqueous medium may be used alone, or two or more kinds of aqueous media may be used in combination.

The surfactant that disperses the material in the dispersion medium may be any of an anionic surfactant, a cationic surfactant, or a nonionic surfactant. Examples thereof include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. One kind of surfactant may be used alone, or two or more kinds of surfactants may be used in combination. The nonionic surfactant may be used in combination with the anionic surfactant or the cationic surfactant.

Examples of the method of dispersing the material in the dispersion medium in a particulate form include known dispersion methods such as a rotating shear type homogenizer, a ball mill having a medium, a sand mill, and a dyno mill.

Examples of the method of dispersing the resin in the dispersion medium in a particulate form include a phase-transfer emulsification method. An example of the phase-transfer emulsification method is a method of dissolving the resin in a hydrophobic organic solvent in which the resin is soluble, adding the basic compound to an organic continuous phase (O phase), and then adding the aqueous medium (W phase) to perform a phase transition from W/O to O/W, thereby dispersing the resin in the aqueous medium in a particulate form.

A volume-average particle size of the particles dispersed in the particle dispersion is, for example, preferably 30 nm or more and 300 nm or less, more preferably 50 nm or more and 250 nm or less, and still more preferably 80 nm or more and 200 nm or less.

The volume-average particle size of the particles in the particle dispersion refers to a particle size at which 50% of the particles are accumulated from a small size side in a particle size distribution measured with a laser diffraction-type particle size distribution analyzer (for example, model number: LS13-320, Beckman Coulter, Inc.). The number of particles to be measured is 10,000.

A content of the particles contained in the particle dispersion is, for example, preferably 5% by mass or more and 50% by mass or less, more preferably 10% by mass or more and 40% by mass or less, and still more preferably 15% by mass or more and 30% by mass or less.

Hereinafter, materials constituting the particles in the dispersion of the binder resin particles and the dispersion of the release agent particles will be described.

### Binder Resin

Examples of the binder resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (for example, acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

Examples of the binder resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

One kind of each of these binder resins may be used alone, or two or more kinds of these binder resins may be used in combination.

As the binder resin, for example, a polyester resin is suitable. Examples of the polyester resin include an amorphous polyester resin and a crystalline polyester resin. As the polyester resin, only an amorphous polyester resin may be used, only a crystalline polyester resin may be used, or an amorphous polyester resin and a crystalline polyester resin may be used in combination.

In a case where the amorphous polyester resin is used in the production of the colorant-containing polyester resin particles, for example, it is preferable that an amorphous polyester resin having the same form as the amorphous polyester resin is contained in the binder resin.

In a case where the crystalline polyester resin is used in the production of the colorant-containing polyester resin particles, for example, it is preferable that a crystalline polyester resin having the same form as the crystalline polyester resin is contained in the binder resin.

### Release Agent

Examples of the release agent include hydrocarbon-based wax; natural wax such as carnauba wax, rice wax, and candelilla wax; synthetic or mineral petroleum-based wax such as montan wax; and ester-based wax such as fatty acid esters and montanic acid esters. The release agent is not limited to the agents.

The melting temperature of the release agent is, for example, preferably 50° C. or higher and 110° C. or lower, and more preferably 60° C. or higher and 100° C. or lower.

The melting temperature of the release agent is determined from a DSC curve obtained by differential scanning calorimetry (DSC) by “peak melting temperature” described in the method for determining the melting temperature in JIS K7121:1987, “Testing methods for transition temperatures of plastics”.

### Aggregation Step (First Aggregation Step)

The aggregation step is a step of aggregating the material particles in a dispersion containing the material particles to form aggregated particles.

The dispersion to be subjected to the aggregation step contains at least the colorant-containing polyester resin particles. For example, it is preferable that the dispersion to be subjected to the aggregation step contains binder resin particles and release agent particles.

In a case where the manufacturing method of the toner according to the present exemplary embodiment includes a second aggregation step (step of forming a shell) described later, the above-described aggregation step is referred to as “first aggregation step”. The first aggregation step is a step of forming a core in a toner having a core/shell structure.

For example, the dispersion to be subjected to the aggregation step is produced by preparing a dispersion of the colorant-containing polyester resin particles, a dispersion of the binder resin particles, and a dispersion of the release agent particles, and then mixing these particle dispersions. The order of mixing these particle dispersions is not limited. Hereinafter, the dispersion obtained by mixing a plurality of kinds of particle dispersions is referred to as “mixed dispersion”.

A mass ratio of the particles contained in the mixed dispersion is, for example, preferably in the following range.

A mass ratio of the binder resin particles and the colorant-containing polyester resin particles as binder resin particles:colorant-containing polyester resin particles is, for example, preferably 100:1 to 100:100, more preferably 100:2 to 100:60, and still more preferably 100:5 to 100:40.

A mass ratio of the binder resin particles and the release agent particles as binder resin particles:release agent particles is, for example, preferably 100:1 to 100:40, more preferably 100:2 to 100:30, and still more preferably 100:5 to 100:20.

For example, it is preferable to adjust a pH of the mixed dispersion to a range of 3 or more and 4 or less after the mixing of the plurality of kinds of particle dispersions. Examples of a means of adjusting the pH of the mixed dispersion include adding an acidic aqueous solution such as a nitric acid aqueous solution, a hydrochloric acid aqueous solution, and a sulfuric acid aqueous solution.

The aggregation step includes, for example, adding an aggregating agent to the mixed dispersion while agitating the mixed dispersion, and heating the mixed dispersion while agitating the mixed dispersion liquid after adding the aggregating agent to the mixed dispersion to raise a temperature of the mixed dispersion.

Examples of the aggregating agent include a surfactant having polarity opposite to the polarity of the surfactant contained in the mixed dispersion, an inorganic metal salt, and a metal complex having a valency of 2 or more. One kind of aggregating agent may be used alone, or two or more kinds of aggregating agents may be used in combination.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the aggregating agent, for example, a metal salt compound having a valency of 2 or more is preferable, a trivalent metal salt compound is more preferable, and a trivalent inorganic aluminum salt compound is still more preferable. Examples of the trivalent inorganic aluminum salt compound include aluminum chloride, aluminum sulfate, polyaluminum chloride, and polyaluminum hydroxide.

An amount of the aggregating agent added is not limited. In a case where the trivalent metal salt compound is used as the aggregating agent, an amount of the trivalent metal salt compound added is, for example, preferably 0.01 parts by mass or more and 10 parts by mass or less, more preferably 0.05 parts by mass or more and 5 parts by mass or less, and still more preferably 0.1 parts by mass or more and 3 parts by mass or less with respect to 100 parts by mass of the binder resin.

A reaching temperature of the mixed dispersion in a case of heating the mixed dispersion is, for example, preferably a temperature based on the glass transition temperature (Tg) of the binder resin particles, for example, (Tg-30° C.) or higher and (Tg° C.) or lower with regard to the binder resin particles.

In a case where the mixed dispersion contains a plurality of kinds of binder resin particles having different Tg's, the lowest temperature among the Tg's is defined as the Tg in the aggregation step.

### Second Aggregation Step

The second aggregation step is a step provided for the purpose of manufacturing a toner having a core/shell structure, and is a step provided after the first aggregation step. The second aggregation step is a step of forming a shell.

The second aggregation step is a step of mixing the dispersion containing the aggregated particles with a dispersion containing resin particles that are to be a shell to aggregate the resin particles to be a shell on a surface of the aggregated particles, thereby forming second aggregated particles.

As the dispersion containing the resin particles to be a shell, for example, at least one selected from a binder resin particle dispersion for forming a core is suitable; a polyester resin particle dispersion is more suitable; and an amorphous polyester resin particle dispersion is still more suitable.

The second aggregation step includes, for example, adding the dispersion containing the resin particles to be a shell to the dispersion containing the aggregated particles while agitating the dispersion containing the aggregated particles, and heating the dispersion containing the aggregated particles, after adding the dispersion containing the resin particles to be a shell, while agitating the dispersion.

A reaching temperature of the dispersion containing the aggregated particles in a case of heating the dispersion containing the aggregated particles is, for example, preferably a temperature based on the glass transition temperature (Tg) of the resin particles to be a shell, for example, (Tg-30° C.) or higher and (Tg-10° C.) or lower with regard to the resin particles to be a shell.

After the aggregated particles or the second aggregated particles have grown to a predetermined size, in order to stop the growth of the aggregated particles or the second aggregated particles before the heating in the coalescence step, a chelating agent for the aggregating agent used in the aggregation step may be added to the dispersion containing the aggregated particles or the second aggregated particles.

Examples of the chelating agent include oxycarboxylic acids such as tartaric acid, citric acid, and gluconic acid; and aminocarboxylic acids such as iminodiacetic acid (IDA), nitrilotriacetic acid (NTA), and ethylenediaminetetraacetic acid (EDTA).

An amount of the chelating agent added with respect to 100 parts by mass of the binder resin particles is, for example, preferably 0.01 parts by mass or more and 5.0 parts by mass or less, and more preferably 0.1 parts by mass or more and less than 3.0 parts by mass.

After the aggregated particles or the second aggregated particles have grown to a predetermined size, in order to stop the growth of the aggregated particles or the second aggregated particles before the heating in the coalescence step, a pH of the dispersion containing the aggregated particles or the second aggregated particles may be increased.

Examples of a means of increasing the pH of the dispersion containing the aggregated particles or the second aggregated particles include addition of at least one selected from the group consisting of an aqueous solution of an alkali metal hydroxide and an aqueous solution of an alkaline earth metal hydroxide.

A reaching pH of the dispersion containing the aggregated particles or the second aggregated particles is preferably, for example, 8 or more and 10 or less.

### Coalescence Step

The coalescence step is a step of heating the dispersion containing the aggregated particles for coalescing the aggregated particles together to form toner particles.

In a case where the second aggregation step is provided before the coalescence step, the coalescence step is a step of heating the dispersion containing the second aggregated particles for coalescing the second aggregated particles to form toner particles. By passing through the second aggregation step and the coalescence step, toner particles having a core/shell structure can be manufactured.

Aspects to be described below are common to the aggregated particles and the second aggregated particles.

A reaching temperature of the dispersion containing the aggregated particles is, for example, preferably a temperature equal to or higher than the glass transition temperature (Tg) of the binder resin, specifically, higher than Tg of the binder resin by 10° C. to 30° C.

In a case where the aggregated particles have a plurality of kinds of binder resins having different Tg's, the lowest temperature among the Tg's is defined as the glass transition temperature in the coalescence step.

After the coalescence step ends, the toner particles in the dispersion are subjected to known washing step, solid-liquid separation step, and drying step, thereby obtaining dry toner particles. As the washing step, from the viewpoint of charging properties, for example, displacement washing may be thoroughly performed using deionized water. As the solid-liquid separation step, from the viewpoint of productivity, for example, suction filtration, pressure filtration, or the like may be performed. As the drying step, from the viewpoint of productivity, for example, freeze drying, flush drying, fluidized drying, vibratory fluidized drying, or the like may be performed.

### Step of Externally Adding External Additive

For example, the manufacturing method of the toner according to the present exemplary embodiment preferably includes a step of externally adding an external additive to the toner particles.

The toner particles and the external additive in a dry state are mixed with each other to perform the external addition of the external additive to the toner particles. The mixing is performed, for example, using a V blender, a Henschel mixer, a Lödige mixer, or the like. Furthermore, coarse particles of the toner may be removed as necessary by using a vibratory sieving machine, a pneumatic sieving machine, or the like.

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂) n, Al₂O₃·2SiO₂, CaCO₃, MgCO₃, BaSO₄, and MgSO₄.

The surface of the inorganic particles as an external additive may have undergone, for example, a hydrophobic treatment. The hydrophobic treatment is performed, for example, by dipping the inorganic particles in a hydrophobic agent. The hydrophobic agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

Usually, the amount of the hydrophobic agent is, for example, 1 part by mass or more and 10 parts by mass or less with respect to 100 parts by mass of the inorganic particles.

Examples of the external additive also include resin particles (resin particles such as polystyrene, polymethyl methacrylate, and melamine resins), a cleaning activator (for example, and a metal salt of a higher fatty acid represented by zinc stearate or fluorine-based polymer particles).

The amount of the external additive externally added with respect to the mass of the toner particles is, for example, preferably 0.01% by mass or more and 5% by mass or less, and more preferably 0.01% by mass or more and 2% by mass or less.

### Electrostatic Charge Image Developing Toner

The toner manufactured by the manufacturing method according to the present exemplary embodiment is, for example, an externally added toner in which an external additive is externally added to the toner particles. The aspect of the external additive is as described above.

The toner particles contain at least the polyester resin and the basic colorant. The toner particles may contain a binder resin other than the polyester resin. The toner particles may contain a release agent.

The total content of the polyester resin with respect to the total amount of the toner is, for example, preferably 40% by mass or more and 95% by mass or less, more preferably 50% by mass or more and 90% by mass or less, and still more preferably 60% by mass or more and 85% by mass or less.

In a case where the toner particles contain the crystalline polyester resin, a content of the crystalline polyester resin is, for example, preferably 3% by mass or more and 30% by mass or less, and more preferably 8% by mass or more and 20% by mass or less with respect to the total amount of the binder resin.

The content of the release agent with respect to the total amount of the toner is, for example, preferably 1% by mass or more and 20% by mass or less, and more preferably 5% by mass or more and 15% by mass or less.

A content of the basic colorant is, for example, preferably 1% by mass or more and 30% by mass or less and more preferably 3% by mass or more and 15% by mass or less with respect to the total amount of the toner.

A volume-average particle size of the toner is, for example, preferably 2 μm or more and 10 μm or less, and more preferably 4 μm or more and 8 μm or less. A method for measuring the volume-average particle size of the toner is as follows.

A particle size distribution of the toner is measured using COULTER MULTISIZER II (manufactured by Beckman Coulter, Inc.) and using ISOTON-II (manufactured by Beckman Coulter, Inc.) as an electrolytic solution. For measurement, a measurement sample in an amount of 0.5 mg or more and 50 mg or less is added to 2 ml of a 5% by mass aqueous solution of a surfactant (for example, preferably sodium alkylbenzene sulfonate) as a dispersant. The obtained solution is added to an electrolytic solution in a volume of 100 ml or more and 150 ml or less. The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 μm. The number of particles to be measured is 50,000. A particle size distribution is drawn from the small size side, and a particle size at which the cumulative percentage is 50% is defined as the volume-average particle size D50v.

An average circularity of the toner is, for example, preferably 0.94 or more and 1.00 or less, and more preferably 0.95 or more and 0.98 or less.

The average circularity of the toner is (peripheral length of circle having the same area as the particle projection image)/(peripheral length of the particle projection image). The average circularity of the toner is obtained by measuring 3,500 particles using a flow-type particle image analyzer (FPIA-3000 manufactured by Sysmex Corporation).

### Developer

The toner manufactured by the manufacturing method according to the present exemplary embodiment may be used as a one-component developer or may be used as a two-component developer by being mixed with a carrier.

The carrier is not particularly limited, and examples thereof include known carriers. Examples of the carrier include a coated carrier obtained by coating the surface of a core material consisting of magnetic powder with a resin; a magnetic powder dispersion-type carrier obtained by dispersing magnetic powder in a matrix resin and mixing the powder and the resin together; and a resin impregnation-type carrier obtained by impregnating porous magnetic powder with a resin.

The magnetic powder dispersion-type carrier or the resin impregnation-type carrier may be a carrier obtained by coating the surface of a core material, that is particles configuring the carrier, with a resin.

Examples of the magnetic powder include magnetic metals such as iron, nickel, and cobalt; and magnetic oxides such as ferrite and magnetite.

Examples of the coating resin and matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, an acrylic acid ester copolymer, a styrene-acrylic acid ester copolymer, a resin having a cycloalkyl group, an acrylic acid ester copolymer having a cycloalkyl group, a straight silicone resin configured with an organosiloxane bond, a product obtained by modifying the straight silicone resin, a fluororesin, polyester, polycarbonate, a phenol resin, and an epoxy resin. For example, an acrylic acid ester copolymer, a styrene-acrylic acid ester copolymer, a resin having a cycloalkyl group, or an acrylic acid ester copolymer having a cycloalkyl group is preferable. The coating resin and the matrix resin may contain other additives such as conductive particles. Examples of the conductive particles include metals such as gold, silver, and copper, and particles such as carbon black, titanium oxide, zinc oxide, tin oxide, barium sulfate, aluminum borate, and potassium titanate.

The surface of the core material is coated with a resin, for example, by a coating method using a solution for forming a coating layer obtained by dissolving the coating resin and various additives (used as necessary) in an appropriate solvent, and the like. The solvent is not particularly limited, and may be selected in consideration of the type of the resin used, coating suitability, and the like.

Specifically, examples of the resin coating method include a dipping method of dipping the core material in the solution for forming a coating layer; a spray method of spraying the solution for forming a coating layer to the surface of the core material; a fluidized bed method of spraying the solution for forming a coating layer to the core material that is floating by an air flow; and a kneader coater method of mixing the core material of the carrier with the solution for forming a coating layer in a kneader coater and then removing solvents.

The mixing ratio (mass ratio) between the toner and the carrier, represented by toner:carrier, in the two-component developer is, for example, preferably 1:100 to 30:100, and more preferably 3:100 to 20:100.

### EXAMPLES

Hereinafter, exemplary embodiments of the invention will be specifically described based on examples. However, the exemplary embodiments of the invention are not limited to the examples.

In the following description, unless otherwise specified, “parts” and “%” are based on mass.

In the following description, the synthesis, the production, the treatment, the measurement, and the like are carried out at room temperature (25° C.±3° C.) unless otherwise specified.

### Production of Amorphous Polyester Resin (A)

The following materials are prepared.

| | | |
|---|---|---|
| Terephthalic acid: | 30 | parts by mole |
| Fumaric acid: | 70 | parts by mole |
| Ethylene oxide adduct of bisphenol A: | 5 | parts by mole |
| Propylene oxide adduct of bisphenol A: | 95 | parts by mole |

The above-described materials are charged into a flask equipped with an agitation device, a nitrogen introduction pipe, a temperature sensor, and a rectification column, the temperature of the reaction solution is raised to 220° C. over 1 hour, and 1 part of titanium tetraethoxide with respect to 100 parts of the above-described materials is added thereto. The temperature of the reaction solution is raised to 230° C. over 30 minutes while distilling off water to be generated, and the dehydration condensation reaction is continued for 1 hour while maintaining the temperature of the reaction solution at 230° C. Thereafter, the temperature of the reaction product is lowered to room temperature. In this manner, an amorphous polyester resin (A) having an acid value of 12.0 mgKOH/g, a weight-average molecular weight of 18,000, and a glass transition temperature of 60° C. is obtained.

### Production of Dispersion (P1) of Colorant-Containing Polyester Resin Particles

The following materials are prepared.

| | | |
|---|---|---|
| Fluorescent colorant (product name: | 2 | parts |
| Basic Violet 11:1, Taoka Chemical Co., Ltd.): | | |
| Amorphous polyester resin (A): | 200 | parts |
| Basic compound: 25% sodium hydroxide aqueous solution: | 0.4 | parts |
| Surfactant: 48.5% sodium dodecyl diphenyl ether | 4.1 | parts |
| disulfonate aqueous solution (product name: | | |
| ELEMINOL MON-7, Sanyo Chemical Industries, Ltd.): | | |
| Deionized water (1): deionized water | 150 | parts |
| at a temperature of 95° C.: | | |
| Deionized water (2): deionized water | 150 | parts |
| at a temperature of 95° C.: | | |
| Deionized water (3): deionized water | 150 | parts |
| at a temperature of 95° C.: | | |

A biaxial kneading extruder (model number: TEM26SS, Shibaura Machine CO., LTD.) is prepared. A barrel of the biaxial kneading extruder used in the present example is formed by connecting a plurality of barrel blocks, and overall L/D is 50.

### Melting Step

A barrel temperature of the biaxial kneading extruder is set to 95° C., and a screw rotation speed is set to 400 rpm. The fluorescent colorant, the amorphous polyester resin (A), and the 25% sodium hydroxide aqueous solution are charged into a raw material inlet of the biaxial kneading extruder, and the biaxial kneading extruder is operated. A surfactant is charged from a fourth block barrel, and the mixture is kneaded to melt the resin, thereby producing a mixture.

### Emulsification Step

While operating the biaxial kneading extruder such that an average supply amount of the mixture is 12 kg/h, the deionized water (1) is charged from a fifth block barrel, the deionized water (2) is charged from a seventh block barrel, and the deionized water (3) is charged from a ninth block barrel, so that the mixture is emulsified to obtain a dispersion (P1) of the colorant-containing polyester resin particles. A concentration of solid contents of the dispersion (P1) of the colorant-containing polyester resin particles is 31%.

A particle size distribution of the particles in the dispersion (P1) of the colorant-containing polyester resin particles is measured with a laser diffraction-type particle size distribution analyzer (model number: LS13-320, Beckman Coulter, Inc.). A volume-average particle size of the particles in the dispersion (P1) of the colorant-containing polyester resin particles is 200 nm.

### Production of Dispersions (P2), (P3), and (P9) to (P14) of Colorant-Containing Polyester Resin Particles

Each of dispersions of the colorant-containing polyester resin particles is produced in the same manner as in the production of the dispersion (P1) of the colorant-containing polyester resin particles, except that the specifications and the operation conditions of the biaxial kneading extruder are changed as shown in Table 1. All volume-average particle sizes of the particles in the dispersion of the colorant-containing polyester resin particles are 200 nm.

### Production of Dispersion (P4) of Colorant-Containing Polyester Resin Particles

The following materials are prepared.

| | | |
|---|---|---|
| Organic solvent (1): ethyl acetate: | 40 | parts |
| Organic solvent (2): isopropanol: | 25 | parts |
| Fluorescent colorant (product name: | 2 | parts |
| Basic Violet 11:1, Taoka Chemical Co., Ltd.): | | |
| Amorphous polyester resin (A): | 100 | parts |
| Basic compound: 10% ammonia water: | 11 | parts |
| Deionized water (4): deionized water | 200 | parts |
| at a temperature of 40° C.: | | |

### Dissolving Step

The organic solvent (1) and the organic solvent (2) are charged into an agitated vessel provided with an agitation device, a condenser, a heater, and a thermometer to prepare a mixed solvent. The temperature in the agitated vessel is kept in a range of 35° C. to 55° C., and while agitating, the fluorescent colorant and the amorphous polyester resin (A) are charged into the agitated vessel and agitated for 60 minutes to dissolve the fluorescent colorant and the resin in the organic solvent.

### Emulsification Step

10% ammonia water is added thereto while maintaining the temperature in the agitated vessel and continuing the agitating, and then the deionized water (4) is added dropwise thereto over 90 minutes to emulsify the contents. The heating of the agitated vessel is stopped, and the temperature of the emulsion is lowered to room temperature. Thereafter, the inside of the agitated vessel is depressurized to 10 kPa while maintaining the temperature in the agitated vessel in a range of 40° C. to 55° C., thereby removing the organic solvent from the emulsion. The emulsion is passed through a sieve, 2.1 parts of a 48.5% sodium dodecyl diphenyl ether disulfonate aqueous solution (product name: ELEMINOL MON-7, Sanyo Chemical Industries, Ltd.) and 30 parts of deionized water are added thereto to obtain a dispersion (P4) of the colorant-containing polyester resin particles.

A concentration of solid contents of the dispersion (P4) of the colorant-containing polyester resin particles is 31%. A volume-average particle size of the particles in the dispersion (P4) of the colorant-containing polyester resin particles is 200 nm.

### Production of Dispersions (P5) to (P8) of Colorant-Containing Polyester Resin Particles

Each of dispersions of the colorant-containing polyester resin particles is produced in the same manner as in the production of the dispersion (P4) of the colorant-containing polyester resin particles, except that the temperature of the emulsification step, and the like are changed as shown in Table 1. All volume-average particle sizes of the particles in the dispersion of the colorant-containing polyester resin particles are 200 nm.

### Production of Dispersion (1) of Amorphous Polyester Resin Particles

The following materials are prepared.

| | | |
|---|---|---|
| Terephthalic acid: | 30 | parts by mole |
| Fumaric acid: | 70 | parts by mole |
| Ethylene oxide adduct of bisphenol A: | 5 | parts by mole |
| Propylene oxide adduct of bisphenol A: | 95 | parts by mole |

The above-described materials are charged into a flask equipped with an agitation device, a nitrogen introduction pipe, a temperature sensor, and a rectification column, the temperature of the reaction solution is raised to 220° C. over 1 hour, and 1 part of titanium tetraethoxide with respect to 100 parts of the above-described materials is added thereto. The temperature of the reaction solution is raised to 230° C. over 30 minutes while distilling off water to be generated, and the dehydration condensation reaction is continued for 1 hour while maintaining the temperature of the reaction solution at 230° C. Thereafter, the temperature of the reaction product is lowered to room temperature. In this manner, an amorphous polyester resin having an acid value of 12.0 mgKOH/g, a weight-average molecular weight of 18,000, and a glass transition temperature of 60° C. is obtained.

40 parts of ethyl acetate and 25 parts of 2-butanol are charged into a container provided with a temperature control unit and a nitrogen replacement unit to prepare a mixed solvent. 100 parts of the amorphous polyester resin is gradually added to the mixed solvent and dissolved, and 10% ammonia aqueous solution (equivalent of 3 times in terms of molar ratio with respect to the acid value of the resin) is added thereto and agitated for 30 minutes. Next, the inside of the container is replaced with dry nitrogen, the temperature of the reaction solution is kept at 40° C., and 400 parts of deionized water is added dropwise to the reaction solution at a rate of 2 parts/min while agitating the reaction solution to emulsify. After the dropwise addition of the deionized water is completed, the temperature of the emulsion is lowered to room temperature (20° C. to 25° C.), and bubbling with dry nitrogen is performed for 48 hours while agitating the emulsion to reduce the total amount of the ethyl acetate and the 2-butanol to 1,000 ppm or less. Deionized water is added to the emulsion to adjust a concentration of solid contents to 20%. In this manner, a dispersion (1) of amorphous polyester resin particles is obtained. A volume-average particle size of the particles in the dispersion (1) of amorphous polyester resin particles is 160 nm.

### Production of Release Agent Particle Dispersion (1)

The following materials are prepared.

| | | |
|---|---|---|
| Paraffin wax (HNP-9, NIPPON SEIRO CO., LTD.): | 100 | parts |
| Deionized water: | 350 | parts |
| Anionic surfactant (product name: | 1 | part |
| NEOGEN RK, DKS Co. Ltd., aqueous solution | | |
| with a concentration of 20%): | | |

The above-described materials are mixed with each other, heated to 100° C., and then subjected to a dispersion treatment using a homogenizer (ULTRA-TURRAX T50, IKA) and a pressure jet-type homogenizer (Manton-Gaulin high-pressure homogenizer, Gaulin Corporation). At a point in time when the volume-average particle size reaches 200 nm, the dispersed resultant is collected, thereby obtaining a release agent particle dispersion (1), having a concentration of solid contents of 20%.

### Example 1

### Manufacturing of Toner Particles

The following materials are prepared.

| | | |
|---|---|---|
| Deionized water: | 7 | parts |
| Dispersion (1) of amorphous polyester resin particles: | 50 | parts |
| Dispersion (P1) of colorant-containing | 13 | parts |
| polyester resin particles: | | |
| Release agent particle dispersion (1): | 10 | parts |
| Anionic surfactant (product name: | 1 | part |
| NEOGEN RK, DKS Co. Ltd., aqueous solution | | |
| with a concentration of 20%): | | |

### First Aggregation Step

The above-described materials are charged into a round stainless flask, 0.1 N nitric acid is added thereto to adjust the pH to 3.5, and 30 parts of a nitric acid aqueous solution of polyaluminum chloride with a concentration of 10% is added thereto. The liquid temperature is adjusted to 30° C. using an oil bath, the mixture is dispersed using a homogenizer (product name: ULTRA-TURRAX T50, IKA). Next, the liquid temperature is raised to 45° C. and maintained for 30 minutes to form first aggregated particles.

### Second Aggregation Step

20 parts of the dispersion (1) of amorphous polyester resin particles is added to the dispersion containing the first aggregated particles, while keeping the liquid temperature of the dispersion containing the first aggregated particles at 45° C., and the mixture is held for 60 minutes to form second aggregated particles.

### Coalescence Step

0.1N sodium hydroxide aqueous solution is added to the dispersion containing the second aggregated particles to adjust the pH to 8.5, and the liquid temperature is raised to 84° C. and maintained for 150 minutes. Next, the mixture is cooled to 20° C. at a rate of 20° C./min, and then the solid content is filtered off, washed with deionized water, and dried. The dried matter is sieved to obtain toner particles (1). A volume-average particle size of the toner particles (1) is 6.0 μm.

### Production of Externally Added Toner

1.5 parts of hydrophobic silica particles (product number: RY50, NIPPON AEROSIL CO., LTD.) and 1.0 part of hydrophobic titanium oxide (product number: T805, NIPPON AEROSIL CO., LTD.) are added to 100 parts of the toner particles (1), and the mixture is mixed using a sample mill at 10,000 rpm for 30 seconds. Thereafter, the mixture is sieved using a vibration sieve having an opening size of 45 μm, thereby obtaining an externally added toner.

### Production of Developer

8 parts of the externally added toner and 92 parts of a carrier (1) shown below are charged into a V blender and agitated for 20 minutes. Thereafter, the mixture is sieved using a sieve having an opening size of 212 μm, thereby obtaining a developer.

### Production of Carrier (1)

14 parts of toluene, 5 parts of a cyclohexyl methacrylate-monoethylaminoethyl methacrylate copolymer (mass ratio: 95:5, weight-average molecular weight: 60,000), and 0.2 parts of carbon black (product number: VXC-72, Cabot Corporation) are charged into a sand mill and dispersed to prepare a dispersion. The dispersion and 100 parts of ferrite particles (average particle size: 35 μm) are placed in a vacuum deaeration kneader, and while agitating, the mixture is dried under reduced pressure to obtain the carrier (1).

### Examples 2 to 12 and Comparative Examples 1 and 2

Each of the toner particles, the externally added toner, and the developer is produced in the same manner as in Example 1, except that the type of the dispersion of the colorant-containing polyester resin particles is changed as shown in Table 1.

### Performance Evaluation

### Image Density Unevenness

The following work and image formation are performed in an environment of a temperature of 23° C. and a relative humidity of 70%. As the dispersibility of the colorant inside the toner particles is lower, charge leakage due to the low dispersibility of the colorant may be more likely to occur, and thus image density unevenness due to the charge leakage may be more likely to occur and an image is formed under a slightly high humidity condition.

As an image forming apparatus for forming the evaluation image, ApeosPort IV C4470 (FUJIFILM Business Innovation Corp.) is prepared. The developer is put into the developing device, and a replenishment toner (the same toner as the toner contained in the developer) is put into the toner cartridge.

100 images having an image density of 30% are output to OS coated paper of A4 size (basis weight: 127 g/m², FUJIFILM Business Innovation Corp.). Image densities at any 10 points on the 100th sheet is measured using a densitometer (X-Rite 938, X-Rite Inc.). A difference (image density difference) between the maximum value and the minimum value of the image densities at the 10 points is calculated, and the image density difference is classified as follows. The results are shown in Table 1.
A: difference in image density is 0.20 or less.
B: difference in image density is more than 0.20 and 0.25 or less.
C: difference in image density is more than 0.25 and 0.30 or less.
D: difference in image density is more than 0.30.

### Heat Storage Properties

2 g of the externally added toner is stored in an environment of a temperature of 55° C. and a relative humidity of 50% for 10 hours. The externally added toner after the storage is visually observed and classified as follows. The results are shown in Table 1.
A: no aggregate is observed.
B: small amount of the aggregate is present.
C: almost all of the particles are aggregated.

TABLE 1

| | Dispersion | | | | | | | | | |
|---|---|---|---|---|---|---|---|---|---|---|
| | of colorant- | | | | | | | | | |
| | containing | | Production step of colorant-containing polyester resin particles | | | | | | | |
| | polyester | | | | | | | Solvent emulsification | | |
| | resin particles | | | | | | | | Dropping | |
| | | Volume- | | Solventless emulsification | | | | | time of | |
| | | average | | | | | Supply | Agitated | specified | Degree of |
| | | particle | Emulsification | | Barrel | Rotation | amount of | vessel | amount of | reduced |
| | Name | size | method | L/D | temperature | speed | mixture | temperature | water | pressure |
| | — | nm | — | — | ° C. | rpm | kg/h | ° C. | min | kPa |
| Example 1 | (P1) | 200 | Solventless | 50 | 95 | 400 | 12 | — | | |
| | | | emulsification | | | | | | | |
| Example 2 | (P2) | 200 | Solventless | 40 | 95 | 600 | 24 | — | | |
| | | | emulsification | | | | | | | |
| Example 3 | (P3) | 200 | Solventless | 80 | 95 | 200 | 3 | — | | |
| | | | emulsification | | | | | | | |
| Example 4 | (P4) | 200 | Solvent | — | | | | 35 to 55 | 90 | 10 |
| | | | emulsification | | | | | | | |
| Example 5 | (P5) | 200 | Solvent | — | | | | 30 to 55 | 30 | 5 |
| | | | emulsification | | | | | | | |
| Example 6 | (P6) | 200 | Solvent | — | | | | 30 to 55 | 120 | 10 |
| | | | emulsification | | | | | | | |
| Example 7 | (P7) | 200 | Solvent | — | | | | 35 to 60 | 30 | 5 |
| | | | emulsification | | | | | | | |
| Example 8 | (P8) | 200 | Solvent | — | | | | 35 to 60 | 90 | 5 |
| | | | emulsification | | | | | | | |
| Example 9 | (P9) | 200 | Solventless | 40 | 90 | 400 | 20 | — | | |
| | | | emulsification | | | | | | | |
| Example 10 | (P10) | 200 | Solventless | 80 | 90 | 400 | 2.5 | — | | |
| | | | emulsification | | | | | | | |
| Example 11 | (P11) | 200 | Solventless | 40 | 95 to105 | 400 | 22 | — | | |
| | | | emulsification | | | | | | | |
| Example 12 | (P12) | 200 | Solventless | 80 | 95 to 105 | 400 | 5 | — | | |
| | | | emulsification | | | | | | | |
| Comparative | (P13) | 200 | Solventless | 12 | 95 | 400 | 12 | — | | |
| Example 1 | | | emulsification | | | | | | | |
| Comparative | (P14) | 200 | Solventless | 80 | 95 | 200 | 2 | — | | |
| Example 2 | | | emulsification | | | | | | | |

| | Production step of colorant-containing polyester resin particles | | | Toner | | |
|---|---|---|---|---|---|---|
| | Time- | | | particle | | |
| | weighted | | | Volume- | Performance evaluation | |
| | average of | | | average | Image | Heat |
| | temperature | Time | T × | particle | density | storage |
| | T | R | ln R | size | unevenness | properties |
| | ° C. | sec | — | μm | — | — |
| Example 1 | 95 | 30 | 323 | 6.0 | A | A |
| Example 2 | 95 | 8.4 | 202 | 6.0 | C | A |
| Example 3 | 95 | 320 | 548 | 6.0 | A | B |
| Example 4 | 45 | 60000 | 495 | 6.0 | B | A |
| Example 5 | 34 | 18000 | 333 | 6.0 | B | A |
| Example 6 | 34 | 90000 | 387 | 6.0 | B | A |
| Example 7 | 55 | 18000 | 539 | 6.0 | A | B |
| Example 8 | 55 | 21600 | 549 | 6.0 | A | B |
| Example 9 | 90 | 12 | 224 | 6.0 | C | A |
| Example 10 | 90 | 420 | 544 | 6.0 | A | B |
| Example 11 | 100 | 9 | 220 | 6.0 | C | A |
| Example 12 | 100 | 240 | 548 | 6.0 | A | B |
| Comparative | 95 | 7 | 185 | 6.0 | D | A |
| Example 1 | | | | | | |
| Comparative | 95 | 400 | 569 | 6.0 | A | C |
| Example 2 | | | | | | |

The manufacturing method of an electrostatic charge image developing toner according to the present disclosure includes the following aspects.

(((1)))

A manufacturing method of an electrostatic charge image developing toner, that includes aggregating and coalescing material particles containing colorant-containing polyester resin particles in a dispersion medium to obtain toner particles, the manufacturing method comprising:
a production step of the colorant-containing polyester resin particles,
wherein the production step of the colorant-containing polyester resin particles includes mixing a basic colorant and a polyester resin while applying heat to obtain a mixture, and emulsifying the mixture, and
in the production step of the colorant-containing polyester resin particles, a time-weighted average T° C. of a temperature of the polyester resin and a time R seconds during which the temperature of the polyester resin is in a range of 35° C. or higher and 100° C. or lower satisfy a relationship of 200≤(T×ln R)≤550.

(((2)))

The manufacturing method of an electrostatic charge image developing toner according to (((1))),

wherein, in an entire production step of the colorant-containing polyester resin particles, the temperature of the polyester resin is in the range of 35° C. or higher and 100° C. or lower.

(((3)))

The manufacturing method of an electrostatic charge image developing toner according to (((1))) or (((2))),

wherein an organic solvent is not used in the production step of the colorant-containing polyester resin particles.

(((4)))

The manufacturing method of an electrostatic charge image developing toner according to any one of (((1))) to (((3))),

wherein the basic colorant includes a basic dye.

(((5)))

The manufacturing method of an electrostatic charge image developing toner according to any one of (((1))) to (((4))),

wherein the polyester resin includes an amorphous polyester resin.

(((6)))

The manufacturing method of an electrostatic charge image developing toner according to any one of (((1))) to (((5))),

wherein a mass ratio of the basic colorant to the polyester resin contained in the colorant-containing polyester resin particles is basic colorant:polyester resin=0.1:99.9 to 20:80.

(((7)))

The manufacturing method of an electrostatic charge image developing toner according to any one of (((1) to (((6))),

wherein a volume-average particle size of the colorant-containing polyester resin particles is 50 nm or more and 500 nm or less.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A manufacturing method of an electrostatic charge image developing toner, that includes aggregating and coalescing material particles containing colorant-containing polyester resin particles in a dispersion medium to obtain toner particles, the manufacturing method comprising:
a production step of the colorant-containing polyester resin particles,
wherein the production step of the colorant-containing polyester resin particles includes mixing a basic colorant and a polyester resin while applying heat to obtain a mixture, and emulsifying the mixture, and
in the production step of the colorant-containing polyester resin particles, a time-weighted average T° C. of a temperature of the polyester resin and a time R seconds during which the temperature of the polyester resin is in a range of 35° C. or higher and 100° C. or lower satisfy a relationship of 200≤(T×ln R)≤550.

2. The manufacturing method of an electrostatic charge image developing toner according to claim 1,
wherein, in an entire production step of the colorant-containing polyester resin particles, the temperature of the polyester resin is in the range of 35° C. or higher and 100° C. or lower.

3. The manufacturing method of an electrostatic charge image developing toner according to claim 1,
wherein an organic solvent is not used in the production step of the colorant-containing polyester resin particles.

4. The manufacturing method of an electrostatic charge image developing toner according to claim 1,
wherein the basic colorant includes a basic dye.

5. The manufacturing method of an electrostatic charge image developing toner according to claim 1,
wherein the polyester resin includes an amorphous polyester resin.

6. The manufacturing method of an electrostatic charge image developing toner according to claim 1,
wherein a mass ratio of the basic colorant to the polyester resin contained in the colorant-containing polyester resin particles is basic colorant:polyester resin=0.1:99.9 to 20:80.

7. The manufacturing method of an electrostatic charge image developing toner according to claim 1,
wherein a volume-average particle size of the colorant-containing polyester resin particles is 50 nm or more and 500 nm or less.
